(19) United States
(12) Patent Application Publication
(10) Pub. No.: US 2006/0237028 A1
(43) Pub. Date: Oct. 26, 2006

(54) Dental floss

(76) Inventor: Nasser W. Hamidy, Milpitas, CA (US)

Correspondence Address: James A. Gavney Jr., 725 Wildwood Lane, Palo Alto, CA, 94303, US

(21) Appl. No.: 11/112,455

(22) Filed: Apr. 21, 2005

(51) Int. Cl. A61C 15/00

(52) U.S. Cl. 132/321

(57) ABSTRACT

Textured and/or patterned dental floss and methods for making the same are disclosed. In accordance with the embodiments of the invention dental floss comprises a ribbon structure with patterned features. The patterned features are periodically or spatially arranged along the ribbon structure of the floss and are preferably protruding, receding, textured, abrasive and/or porosus, such as to aid cleaning of inter-proximal regions of the teeth and gums and/or aid in the application of a medication or antiseptic to the inter-proximal regions of teeth and gum while flossing. In accordance with the method of the invention, the dental floss is made by forming textured and/or patterned sheet using an extrusion process, a co-extrusion process, a hot-melt process, a laminating process, an embossing process or any combination thereof. The patterned sheets are then converted into elongated ribbons with patterned features.

### FIELD OF THE INVENTION

This invention relates generally to dental floss. More specifically this invention relates to textured and/or patterned dental floss and methods for making the same.

### BACKGROUND

The origins of dental floss are believed to be ancient. Researchers have found dental floss-like structures wedged between the teeth of prehistoric humans. Levi Spear Parmly (1790-1859), a New Orleans dentist, has been credited as being the inventor of what is now referred to as dental floss. As early as 1815, Parmly taught that healthier and cleaner teeth and gums could be achieved by flossing regularly with a thread of silk. The Codman and Shurtleft Company started producing commercially available quantities of dental floss as early as 1882 and Johnson and Johnson Company patented the first nylon dental floss in 1898.

Since the 1800's the use of dental floss has become a part of main stream oral hygiene and many new types of dental floss have been developed in both string forms and in tape forms. Regardless, most, if not all, dental floss that is available to day is made using fiber or thread processing technologies similar to those used to make the silk dental floss of the 1800's. Because of the proven importance of flossing for maintain healthy teeth and gums and the recent evidence linking a persons oral-health to the persons overall health, there is a continued need to develop more effective and user-friendly types of dental floss.

### SUMMARY OF THE INVENTION

The present invention is directed to dental floss and methods for making dental floss. In accordance with the embodiments of the invention, dental floss comprises a ribbon structure. The ribbon structure is formed from sections of a first material and sections of a second material that are inter-dispersed between each other. For example, the first material is a smooth polymeric material and the second material is textured polymeric material with the same or different composition than the first polymeric material.

In accordance with further embodiment of the invention, dental floss includes a ribbon structure formed from a first material with a plurality of patterned features along at least one surface of the ribbon structure. The patterned features can be protrusions and/or indentations along a surface of the first material, a second material that periodically attached to or adhered to the surface of the first material or a combination thereof. In accordance with the embodiments of the invention, the ribbon structure is preferably formed from a polymeric material such a polyester, polyamide, a polyurethane and the patterned features are formed form a polymeric material, such as rubber, silicone, plastic. In accordance with yet further embodiments of the invention, the first and/or the second material is formed from a woven material or materials that is woven from an number of natural and/or synthetic fibers.

In accordance with further embodiments of the invention, a ribbon structure is formed from a non-porous or non-absorbent polymeric material, such as polyester, polyamide, a polyurethane and the patterned features are formed from an absorbent and porous material, such as a woven material, a sponge material, a foam material or a combination thereof. The patterned features can be latent with or contain a medication and/or antiseptic that is expelled onto teeth and gums during a flossing operation.

In accordance with the embodiment of the invention, dental floss is made by forming patterned sheets comprising one or more flexible material. The patterned sheets are then converted or cut into elongated strips or ribbons with patterned features, such as described above. The patterned sheets can be formed by a co-extrusion process, where a material or materials with different properties are extruded into a single sheet; a hot-melt process, whereby layers or a material or materials are pressed together and melted into a single sheet; a laminating process, whereby layers of a material or materials are glue together into a single sheet; an embossing process, whereby patterns are impressed into a sheet formed from a material or materials; or any combination thereof.

### BRIEF DESCRIPTION OF FIGURES

FIG. 1 shows a schematic representation of a patterned sheet used to makes dental floss, in accordance with the embodiments of the invention.

FIG. 2A-D show schematic representations of dental floss structures with patterned features, in accordance with the embodiments of the invention.

FIG. 3 is a block diagram outlining steps for making dental floss, in accordance with embodiments of the invention.

FIG. 4 shows a schematic representation of a system for making dental floss, in accordance with the embodiments of the invention.

FIG. 5A-D show cross-sectional views of sections of dental floss with pattern features along a surfaces of ribbon structures, in accordance with the embodiments of the invention.

### DETAILED DESCRIPTION OF THE INVENTION

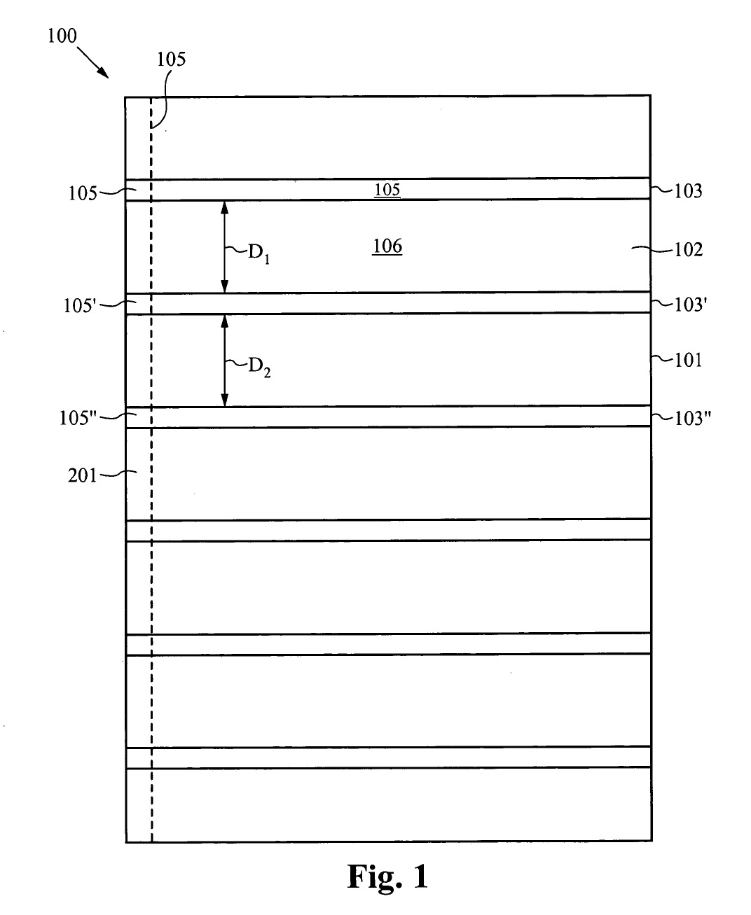

FIG. 1 shows a schematic representation of a patterned sheet 100 used to makes dental floss, in accordance with the embodiments of the invention. The patterned sheet 100 is preferably formed or partially formed a sheet 101 of flexible material, such as a flexible polymeric material or plastic material. Alternatively, the sheet 101 is a woven material.

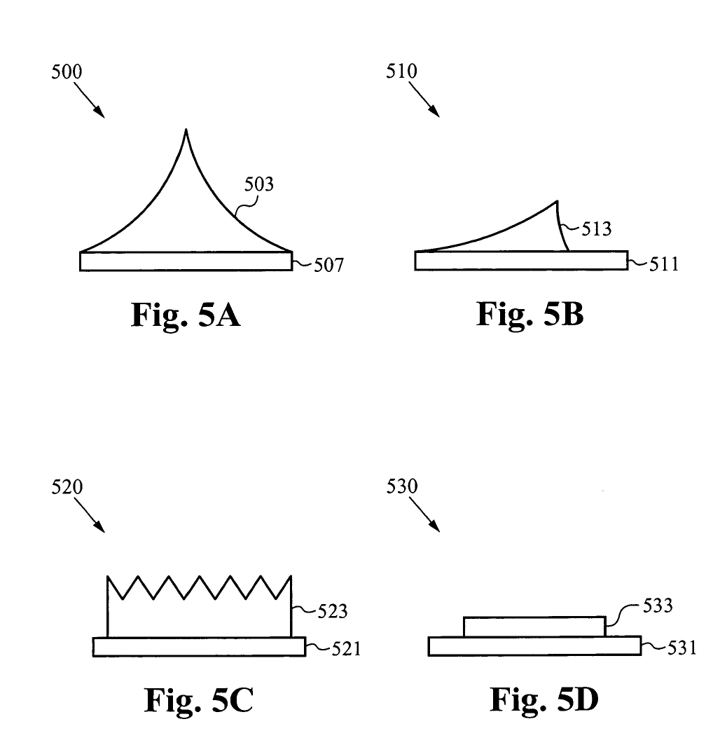

Still referring to FIG. 1, the patterned sheet 100 includes patterned sections or regions 103 and 103′ and 103′ that protrude from, recede from or are flush with surfaces 102 and of the sheet 101. The patterned sections or regions 103 and 103′ and 103′ are formed from the same material as the sheet 101 or a different material from the sheet 101. Preferably, patterned sections or regions 103 and 103′ and 103′ are textured, include an abrasive and/or are more porous that the surfaces 102 of the sheet 101. In accordance with the embodiments of the invention, the sections or regions 103 and 103′ and 103′ are embossed into the sheet 101 and can be made to have micro-textured surfaces, such as described with reference to FIG. 5C.

In accordance with the embodiments of the invention, the patterned sections or regions 103 and 103′ and 103′ are formed from a woven material, a sponge material or a foam material that is laminated or otherwise attached to the sheet 101. Alternatively, the patterned sections or regions 103, 103′ and 103″ are formed by co-extruding a fist material that form first sections 106 and a second material that from second sections 105, where in the first sections 106 and the second sections 105 have different physical properties. In accordance with the embodiments the invention the first material and the second material are different materials or alternatively the first material and the second material are the same material but with a different physical structure or property, such a different density. Also, one or both of the first sections 106 and the second sections 105 can be patterned or micro-patterned during a co-extrusion process or after the co-extrusion process, such that the first sections 106 or the second sections 105 are more porous and/or more abrasive than the other of the first sections 106 and the second sections 105.

Regardless of what material or materials are used to make the patterned sheet 100, or what processes are used to make the patterned sheet 100, the patterned sheet 100 is converted or cut into strips or ribbon 201, such as indicated by the dotted line 105. The strips or ribbons 201 includes patterned features 105, 105′ and 105″ that preferably facilitate cleaning teeth or gums and/or the application of a medication and/or an antiseptic to teeth and gum while flossing with a section of the strip or ribbon 201. In accordance with the embodiments of the invention, the patterned features 105, 105′ and 105″ are spatially separated by distances D₁ and D₂, wherein D₁ and D₂ are the same or different.

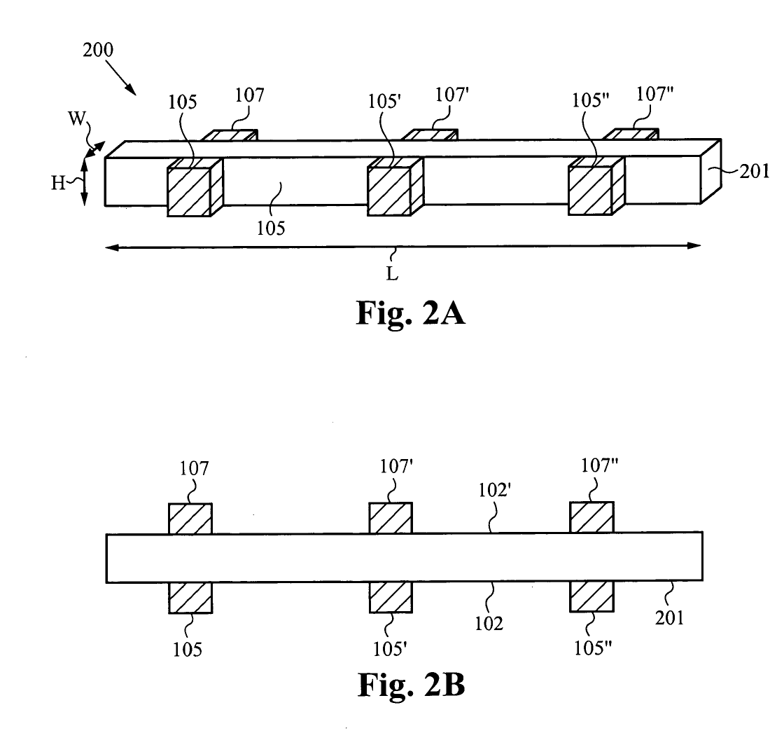

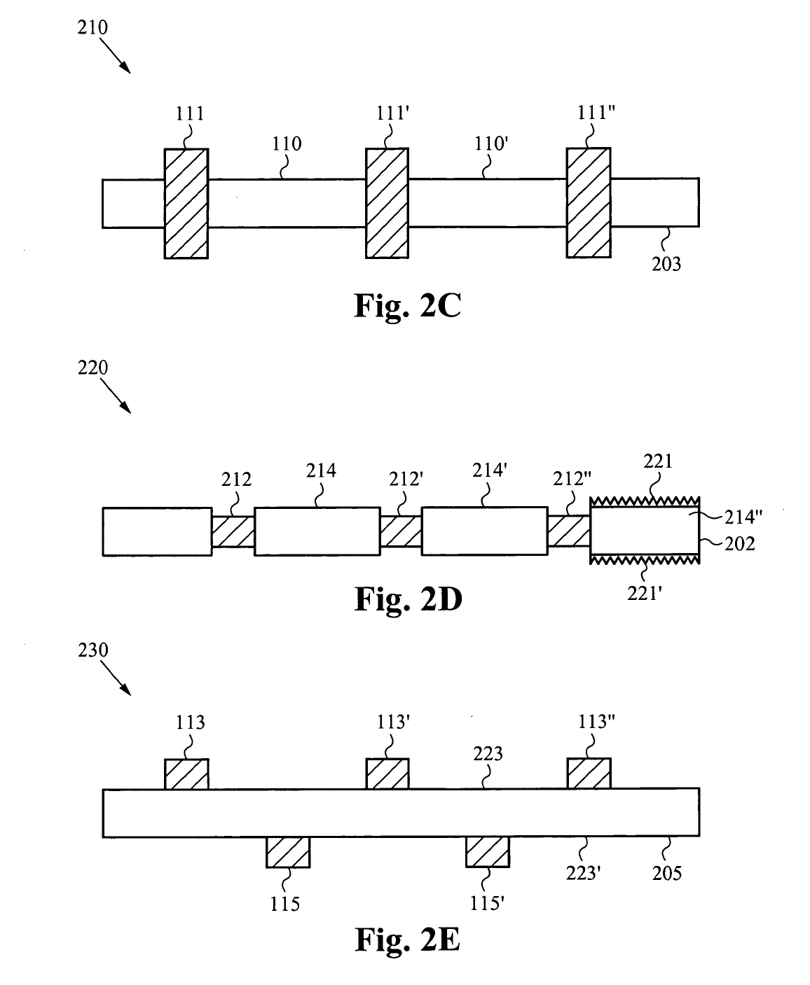

FIG. 2A shows a perspective view of a floss structure 200 that includes a ribbon structure 201 with patterned features 105, 105′ and 105″ spatially arranged along a surface 105 of the ribbon structure 201, in accordance with the embodiment of the invention. The floss structure 201 can have any suitable length (L) for the application at hand. For example, a floss structure 200 can be rolled onto a spool that can be packaged into a dispenser (not show) for despising selectable lengths of the floss structure 200. Alternatively, the floss structure 200 can be cut into smaller lengths suitable for single use flossing and dispensed in any number of different ways. Ends of the floss structure 200 or ribbon structure 201 can include loop features (not shown) for holding and manipulating the floss structure 200 with fingers an/or a flossing implement during a flossing operation. The height (H) and the width (W) of the ribbon structure 201 are of appropriate dimensions for fitting and manipulating the floss structure 200 through spaces between teeth and gums. Preferably the height (H) is greater than the width (W). The height (H) can range from less than 1.0 mm to more than 3.0 mm, but preferably the width (W) is 1.0 mm or less. As described above, patterned features 105, 105′ and 105″ are formed using an extrusion process, a co-extrusion process, a hot-melt process, a laminating process, an embossing process, or any combination thereof.

FIG. 2B, shows a top view of the floss structure 200 that includes the ribbon structure 201 with patterned features 107, 107′ and 107″ spatially positioned along a surface 102′ of the ribbon structure 201 that is opposed to the surface 102 of the ribbon structure 201. The patterned features 107, 107′ and 107″ are formed from the same material or materials as the patterned features 105, 105′ and 105″ or are formed from a different material or materials. The patterned features 107, 107′ and 107″ are formed using an extrusion process, a co-extrusion process, a hot-melt process, a laminating process, an embossing process, or any combination thereof.

Now referring to FIGS. 2A-B, while the patterned features 105, 105′, 105″, 107, 107′ and 107″ are all shown as protruding and having substantially rectangular geometries, it will be clear to one skilled in the art from the description above and below that patterned features 105, 105′, 105″, 107, 107′ and 107″ can have any number of geometries or combinations of geometries.

FIG. 2C shows a cross-section view of a floss structure 210 that includes a ribbon structure 203 with patterned features 111, 111′ and 111″, in accordance with further embodiments of the invention. The patterned features 111, 111′ and 111″ are inter-dispersed between sections 110 and 110′ of the ribbon structure 203. The patterned features 111, 111′ and 111″ either completely surround the ribbon structure 203 or divide the ribbon into segregated segments 110 and 110′. Preferably, the patterned features 111, 111′ and 111″ are formed from a different material than the segregated segments 110 and 110′ and/or have different physical properties from the segregated segments 110 and 110′, such as described above. The floss structure 210 can be formed by an extrusion process, a co-extrusion process, a hot-melt process, a laminating process, an embossing process, or any combination thereof.

FIG. 2D shows a floss structure 220, in accordance with yet further embodiments of the invention. The floss structure 220 includes a ribbon structure 202 with sections 214, 214′ and 214″ of the ribbon structure 202 inter-dispersed between patterned features 212, 212′ and 212″. The patterned features 212, 212′ and 212″ are recessed relative surfaces 221 and 221″ of the sections 214, 214′ and 214″. In accordance with the embodiments of the invention, the surfaces 221 and 221′ or a portion of the surfaces 221 and 221′ of the sections 214, 214′ and 214″ are textured or micro-textured. The patterned features 212, 212′ and 212″ can made from the same material or materials as the sections 214, 214′ and 214″ or can be made from a different material or materials as the sections 214, 214′ and 214″. The floss structure 220 and can be formed by an extrusion process, a co-extrusion process, a hot-melt process, a laminating process, an embossing process, or any combination thereof.

FIG. 2E shows a cross-sectional view of the floss structure 230, in accordance with still further embodiments of the invention. The floss structure 230 includes a ribbon structure 205 with patterned features 113, 113′ and 113″ and 115 and 115′ that are positioned in a staggered arrangement along opposed surfaces 223 and 223, respectively, of the ribbon structure 205.

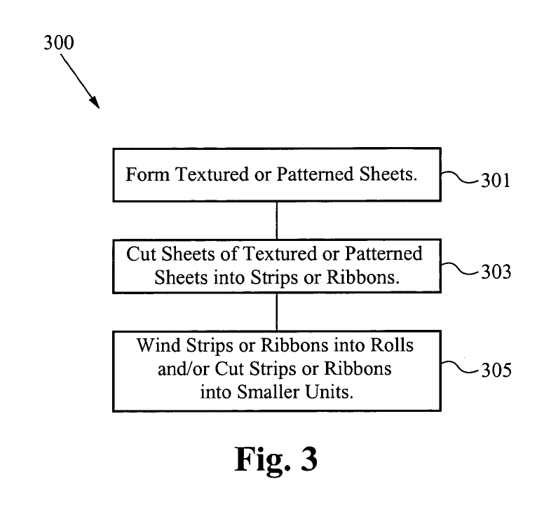

FIG. 3 a block diagram 300 outlining the steps for making dental floss, in accordance with the method of the invention. In the step 301, textured or patterned sheets are formed using any process or combination of processes, such as described above. Specifically, the textured or patterned sheets are formed using an extrusion process, a co-extrusion process, a hot-melt process, a laminating process, an embossing process, or any combination thereof. After the textured or patterned sheets are formed in the step 301, in the step 303 the textured or patterned sheets are converted or cut up into strips or ribbons that have patterned features spatially arranged along the strips or ribbons, such as described with reference to FIG. 1 and FIGS. 2A-E. After the textured or patterned sheets are converted or cut into strips or ribbons in the step 303, in the step 305 the strips or ribbons are packaged. For example, the strips or ribbons are rolled onto a spool and placed in a suitable dispenser and/or the strips or ribbons are converted or cut into smaller units and packaged in any suitable packaging means.

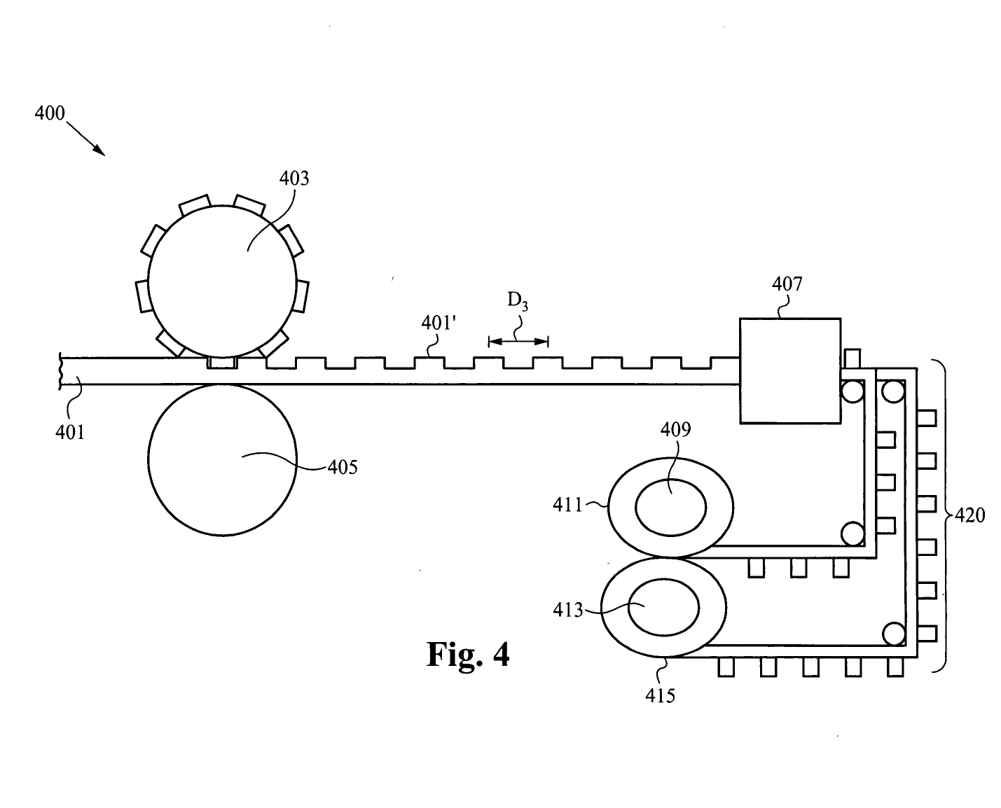

FIG. 4 shows a schematic diagram of a system 400 for making dental floss, in accordance with the embodiments of the invention. A sheet of material 40 is extruded, or otherwise formed, and fed through a patterning mechanism or stage, which can include one or more drums, wheels or rollers 403 and 405 that emboss, hot melt, press, laminate or otherwise form a patterned sheet 401′ with patterned features spatially arranged and separated by a distance D₃ along the patterned sheet 401′, such as described above. The patterned sheet 401′ is fed into a converting station or mechanism 420 that can include a cutting tool 407 that converts or cuts the patterned sheets 401′ into elongated strips or ribbons, such as described with reference to FIG. 1. The converting station or mechanism 420 can also include any number of winders 409 and 413 for winding or collecting the strips or ribbons into rolls 411 and 415. The rolls 411 and 415 can be moved to another converting station or mechanism (not shown) where the strips or ribbons are cut into smaller units and packaged.

FIG. 5A-D show cross-sectional views of sections of dental floss that include a pattern feature along a surface of the a ribbon structure, in accordance with the embodiments of the invention. FIG. 5A shows a section of dental floss 500 with a ribbon structure 507 and a sloped or pointed patterned feature 503 along a surface of the a ribbon structure 507; FIG. 5B shows a section of dental floss 510 with a ribbon structure 511 and an angled or asymmetrically sloped patterned feature 513 along a surface of the a ribbon structure 511; FIG. 5C shows a section of dental floss 520 with a ribbon structure 521 and micro-textured patterned feature 523 along a surface of the a ribbon structure 521; FIG. 5D shows a section of dental floss 510 with a ribbon structure 531 and a substantially rectangular patterned feature 533 along a surface of the a ribbon structure 531. FIGS. 5A-D are provided as examples only and it will be clear to one skilled in the art that patterned features along a ribbon structure of dental floss can have any number of different geometries and combination of geometries.

The present invention has been described in terms of specific embodiments incorporating details to facilitate the understanding of the principles of construction and operation of the invention. As such, references, herein, to specific embodiments and details thereof are not intended to limit the scope of the claims appended hereto. It will be apparent to those skilled in the art that modifications can be made in the embodiment chosen for illustration without departing from the scope of the invention.

What is claimed is:

1. Dental floss comprising:
a) an elongated ribbon structure formed from a first material; and
b) and plurality of patterned features on at least one surface of the ribbon structure.

2. The dental floss of claim 1, wherein the ribbon structure is formed from a polymeric material.

3. The dental floss of claim 2, wherein polymeric material is a material selected from the group consisting of polyester, polyamide, a polyurethane.

4. The dental floss of claim 1, wherein the plurality of patterned features are formed from a first material.

5. The dental floss of claim 1, wherein the plurality of patterned features are formed from a second material that is different from the first material.

6. The dental floss of claim 5, wherein the second material is a polymeric.

7. The dental floss of claim 6, wherein polymeric material is a material selected from the group consisting of rubber, silicone, plastic.

8. The dental floss of claim 1, wherein the first material is a woven material.

9. The dental floss of claim 1, patterned features are formed from a woven material.

10. The dental floss of claim 1, wherein patterned features are formed form an absorbent material.

11. The dental floss of claim 10, wherein the absorbent material is a sponge material or a foam material.

12. Dental floss comprising a ribbon structure comprises first sections formed from a first material inter-dispersed between second sections formed from a second material that is different form the first material.

13. The dental floss of claim 12, wherein surfaces of the first sections are substantially smooth and surfaces of the second sections are textured.

14. An oral hygiene system comprising:
a) a ribbon structure formed form a first material; and
b) a plurality of medicated features formed from a second material and coupled to at least one surface of the ribbon structure.

15. The oral hygiene system of claim 14, wherein the first material is a polymeric material.

16. The oral hygiene system of claim 15, wherein polymeric material is a material selected from the group consisting of polyester, polyamide, a polyurethane.

17. The oral hygiene system of claim 14, wherein the second material is a porous absorbent material.

18. The oral hygiene system of claim 17, wherein the porous absorbent material is a material selected from the group consisting a woven material, a sponge material and a foam material.

19. A method of making a dental floss comprising:
a) forming sheets with patterned structures; and
b) converting the sheets into elongated ribbons with patterned features corresponding to sections of the patterned structures.

20. The method of claim 19, wherein the patterned sheets are formed using one or process selected from the group consisting of an extrusion process, a co-extrusion process, a hot-melt process, a laminating process, an embossing process.

21. The method of claim 20, wherein the sheets comprise one or more material selected from the group consisting of a polymeric material, a sponge material, a foam material and a woven material.
